(19) United States
(12) Patent Application Publication
(10) Pub. No.: US 2005/0148250 A1
(43) Pub. Date: Jul. 7, 2005

(54) Reinforcement composite for a bituminous roofing membrane and method of making the composite

(76) Inventors: Terence J. O'Connor, Mississauga (CA); Donald Kirk, Indianapolis, IN (US)

Correspondence Address: John M. Vasuta, Esq.;Bridgestone Americas Holding, Inc., 1200 Firestone Parkway, Akron, OH, 44317, US

(21) Appl. No.: 10/990,646

(22) Filed: Nov. 17, 2004

Related U.S. Application Data
(60) Provisional application No. 60/523,516, filed on Nov. 19, 2003.

(51) Int. Cl. B32B 5/26; D04H 5/02; B32B 17/02; B32B 17/12; B32B 13/00

(52) U.S. Cl. 442/2; 442/50; 442/17; 442/24; 442/54

(57) ABSTRACT

A roofing membrane (10) is formed by impregnating and coating a composite material (11) with a bituminous material. The composite material (11) is formed with a first layer (12) made of a non-woven polyester mat. A second layer (13) is positioned adjacent to the first layer (12) and is formed as a non-woven fiberglass scrim. An optional third layer (14) is positioned adjacent to the second layer (13) and is formed of a non-woven polyester scrim. A fourth layer (15) is positioned adjacent to the third layer (14) and is made of a non-woven polyester mat. A fifth layer (16) is positioned adjacent to the fourth layer (15) and is also a non-woven polyester mat. The layers (12, 13, 14, 15, 16) may be attached by needle punching to form the composite material (11).

### FIELD OF THE INVENTION

This invention relates to a reinforcement composite and bituminous membranes made therefrom.

### BACKGROUND OF THE INVENTION

Bituminous roofing membranes have found widespread use in the roofing industry. Typically, these membranes are provided on a roll and applied to a flat or low slope roof as adjacent, overlapped strips of material adhered to each other and to the roof.

In the past, these membranes were formed with a composition having, for example, three layers of material, such as a non-woven scrim sandwiched between polyester and/or fiberglass mats. These layers were then fed together through a tank of heated bituminous material that is usually asphalt based. The asphalt acted as an adhesive to bind the layers together to form the membrane. A problem with this process is, however, that too much asphalt between the layers of reinforcement could result in an overly stiff membrane that is susceptible to cracking or wrinkling, and too little penetration of the asphalt could result in delamination of the layers of material.

More recently, the layers of mats and scrim have been held together by an adhesive and then the composite is provided to the hot asphalt-like bath. However, it is important that the asphalt can penetrate through the mats and into the scrim to prevent delamination. But for known composites, such penetration or “strike through” is often not obtained because it is deterred by the adhesive. Moreover, the adhesive itself may be subject to retaining moisture which will ultimately result in the potential for delamination.

Thus, the need exists for a composite that can be easily penetrated by the bituminous material to avoid delamination while at the same time providing a resulting membrane which is not overly stiff or rigid so as to facilitate coating.

### SUMMARY OF THE INVENTION

In general, a composite material for reinforcing roofing membranes made in accordance with the present invention includes a first layer in the form of a mat, a second layer in the form of a non-woven scrim made of a fiberglass material, an optional third layer in the form of a non-woven scrim made of a polyester material, a fourth layer in the form of a mat, and a fifth layer in the form of a mat, each layer being adhered mechanically to its adjacent layer without the use of an adhesive.

The composite material is made from a method including the steps of forming a first mat layer, forming a first scrim layer, positioning the first scrim layer adjacent to the first mat layer, forming a second scrim layer, positioning the second scrim layer adjacent to the first scrim layer, forming a second mat layer, positioning the second mat layer adjacent to the second scrim layer, forming a third mat layer, positioning the third mat layer adjacent to the second mat layer, and mechanically attaching the layers together to form the composite material without the use of an adhesive.

A roofing membrane made in accordance with the present invention includes a single laminate composite material impregnated and coated by a bituminous material, the composite material including a first layer in the form of a mat, a second layer in the form of a non-woven scrim made of a fiberglass material, a third layer in the form of a non-woven scrim made of a polyester material, a fourth layer in the form of a mat, and a fifth layer in the form of a mat.

### BRIEF DESCRIPTION OF THE DRAWINGS

FIG. 1 is an exploded perspective view showing the layers of a composite material made in accordance with the present invention.

FIG. 2 is a sectional view taken through an assembled composite material.

FIG. 3 is a sectional view similar to FIG. 2 but showing the finished roofing membrane wherein the composite has been coated with and penetrated by the bituminous material.

FIG. 4 is a perspective view of a layer of the material of FIG. 1 showing it in a cross-lap configuration.

### DETAILED DESCRIPTION OF ILLUSTRATIVE EMBODIMENTS

A. General

The composite includes warp and weft yarns of both polyester and fiberglass positioned between polyester mats. In one embodiment, three polyester mats are employed, where one mat is positioned above the warp and weft yarns, and two mats are positioned below the warp and weft yarns. The polyester mats positioned below the yarns are preferably cross-lapped. The yarns are preferably a part of one or more scrim layers. In one embodiment, two scrim layers are present, where one scrim is a polyester scrim and the other is a fiberglass scrim. In another embodiment, a single scrim is present that includes alternating polyester and fiberglass yarns in both directions (i.e. alternating warp and weft yarns).

B. Preferred Embodiment

1. General

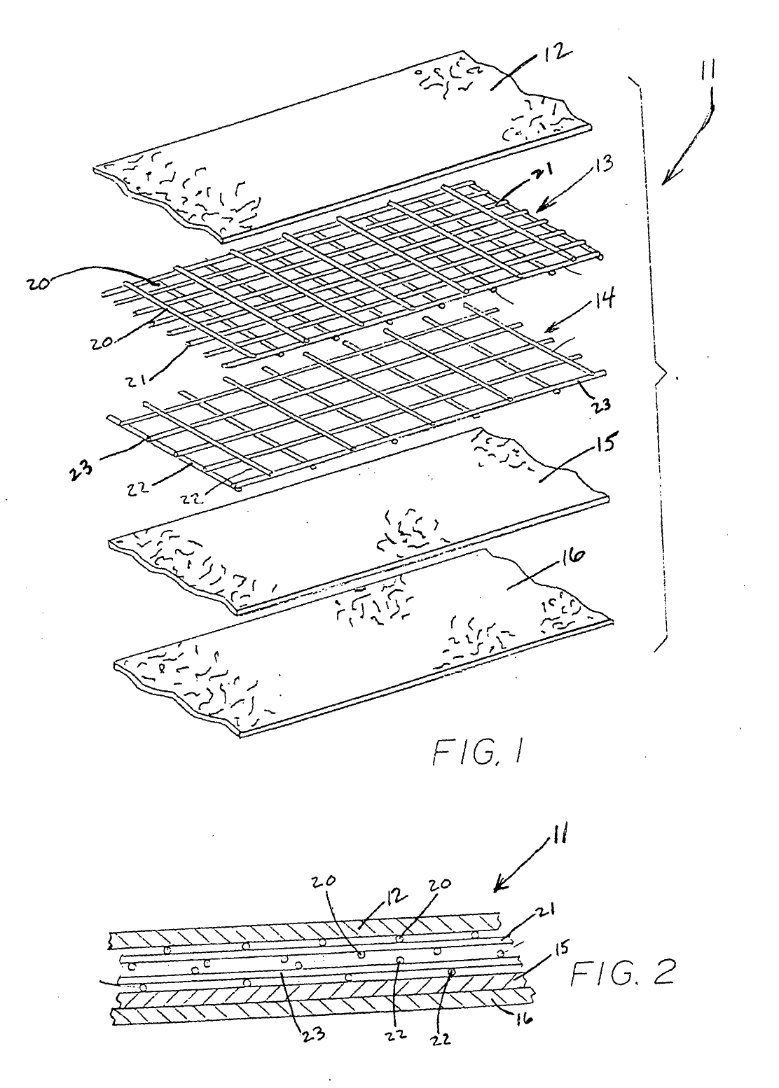

One embodiment of the composite is shown in FIGS. 1-3. The composite 11 includes top layer 12, upper scrim 13, optional lower scrim 14, first bottom layer 15, and second bottom layer 16.

2. Top Layer (Mat)

Top layer 12 is preferably a non-woven polyester mat. The term non-woven refers to a mechanically entangled mass of fibers or yarns. The polyester yarns are preferably low-density staple fibers (i.e. cut to a fixed length) preferably having a length of about three inches and a diameter of about three denier. The preferred non-woven polyester mat is preferably constructed by mechanically fastening the fibers; means of mechanically fastening fibers are known such as carding and needle punching. Optionally, the mats are constructed without employing an adhesive binder. Alternatively and adhesive or binder may be used. Prior to construction of the composite, the preferred non-woven polyester mat preferably has a weight of about 20 to about 40 (preferably about 30) grams per square meter.

3. Bottom Layer (Mats)

Bottom layers 15 and 16 are also non-woven polyester mats and can generally be characterized in the same fashion as top layer 12. In one preferred embodiment, however, bottom layers 15 and 16 and constructed with cross-laps as shown in FIG. 4. Specifically, the non-woven mats may be folded, as at 18, in an accordion fashion to form an angle 19 across the width of the layer and folded back across the width at a similar angle so as to ultimately achieve complete coverage through the entire length of each layer. The cross-laps are mechanically entangled such as by light needle punching. Angle 19 is preferably in the range of 60° to 89°, preferably 65° to 87°, and more preferably 70° to 85°. By cross-lapping layers 15 and 16, the thickness thereof is essentially doubled along with the weight, which is generally about 40 to about 80 (preferably about 60) grams per square meter. The positioning and crosslapping of layers 15 and 16 help to provide adequate cross-direction strength in the composite. Advantageously, certain embodiments of this invention provide a composite that is isotropic with respect to strength in the cross machine direction and machine direction.

4. Scrims

Upper scrim layer 13, which is positioned directly below layer 12 in the finished composite 11, is preferably a non-woven directional fiberglass scrim, although embodiments include warp knit weft inserted scrims. In a preferred non-woven directional fiberglass scrim, scrim 13 includes three layers of yarns that are positioned with the warp yarns 20 alternating above and below the plane of the weft yarns 21. Thus, warp yarns 20 extend longitudinally along the length of composite 11, and weft yarns 21 extend laterally across composite 11. Warp yarns 20 can be adhered to weft yarn 21 by using conventional binders such as a crosslinkable acrylic resin or like adhesive.

With respect to the number of warp and weft fiberglass yarns (i.e., the number of yarns in the machine direction and the number of yarns in the cross-machine direction per inch), scrim 13 can include from about 1 to about 10 yarns in the machine direction and from about 1 to about 10 yarns in the cross-machine direction per inch. Preferably, the scrim will include four yarns in the machine direction and four yarns in the cross-machine direction per inch (i.e., a 4×4 scrim). In another embodiment, scrim 13 includes six yearns per inch in the machine direction and six yarns per inch in the cross direction (i.e., a 6×6 scrim). In a further embodiment, scrim 13 may comprise more yarns in one direction than the other. For example scrim 13 may have more yarns per inch in the cross direction than the machine direction or vice versa. In one certain embodiment, scrim 13 has six yarns per inch in the machine direction and more than six yarns per inch in the cross direction. The fiberglass yarns are generally about 150 1/0 to about 18 1/0 (about 330 decitex to about 2640 decitex), and more preferably about 37 1/0 (about 1320 decitex).

Optional lower scrim layer 14, which is positioned below scrim layer 13 in the finished composite 11, is preferably a non-woven directional polyester scrim, although embodiments include warp yarn weft inserted scrims. In a preferred non-woven directional polyester scrim, scrim 14 includes three layers of yarns that are positioned with the warp yarns 22 alternating above and below the plane of the weft yarns 23. Thus, warp yarns 22 extend longitudinally along the length of composite 11, and weft yarns 23 extend laterally across composite 11. Warp yarns 22 can be adhered to weft yarn 23 by using conventional binders such as a crosslinkable acrylic resin or like adhesive.

With respect to the number of warp and weft polyester yarns (i.e., the number of yarns in the machine direction and the number of yarns in the cross-machine direction per inch) the scrim can include from about 1 to about 20 yarns in the machine direction and from about 1 to about 10 yarns in the cross-machine direction per inch. Preferably, this scrim will include three yarns in the machine direction and three yarns in the cross-machine direction per inch (i.e., a 3×3 scrim). The polyester yarns are generally about 250 to about 2,500 denier, and more preferably about 1,000 denier.

### a. Alternate Embodiment

In alternate embodiment, the polyester and fiberglass scrims can be integrated into one single non-woven directional scrim layer. In this embodiment, (not shown in the drawings), the scrim includes three layers of yarns that are positioned with the warp yarns alternating above and below of the plane of the weft yarns, as generally shown in the previous embodiment. The yarns in the individual layers, however, include alternating polyester and fiberglass yarns. These yarns are preferably adhered together using conventional binders such as crosslinkable acrylic resins or like adhesives.

C. Composite Manufacture

In constructing the five-layered composite, which is generally shown in the drawings, the preferred process begins with attaching scrim layer 13 to scrim layer 14. These scrim layers are preferably attached via an adhesive. In one embodiment, fiberglass and polyester scrims are preferably pre-combined; that is, they may be formed at one time or in one iteration.

The next step of the preferred process includes positioning top layer 12 above the two-layered scrim composite and positioning bottom layers 15 and 16 below the two-layered scrim composite. Reference to the terms “above” and “below” are used as a matter of convenience inasmuch as those skilled in the art will appreciate that the composite can be manufactured upside down, e.g., by positioning mats 15 and 16 above the two-layered scrim composite manufactured in the previous step. Typically, the thickness of the five-layers after positioning them on top of one another will be about 30 to about 40 mils thick. This five-layered sandwiched structure is then needle punched, which serves to mechanically fasten the five layers to one another and reduces the thickness of the needle-punched composite to about 35 mils.

Following the step of mechanically fastening the layers, the composite is treated with a stiffening binder. For example, the needle-punched composite can be immersed into a bath of a crosslinkable acrylic binder. The composition or mixture that includes the crosslinkable acrylic binder will also preferably include a crosslinking agent such as a melamine, a phenol formaldehyde, or a urea formaldehyde crosslinking agent.

After being treated with the stiffening binder, the composite is then dried and cured. The step of drying and curing preferably includes placing a composite within a drying oven which is preferably kept at a temperature of about at least 350° F. Those skilled in the art will appreciate that at these temperatures, curing will follow drying. In other words, once the water has been driven from the article, there is sufficient energy (i.e., heat) to activate the crosslinking of the acrylic resin. Following this curing step, the composites are typically cut to width, rolled, and shipped.

After drying and curing of the composite that has been treated with the stiffening binder, the composite will generally include from about 15 to about 25% by weight binder based on the weight of the polyester mat components (i.e., the weight of the polyester mats).

D. Use

The composites of this invention are preferably employed as reinforcing composites for bituminous roofing membranes. As those skilled in the art will appreciate, this use typically entails saturating the membrane with a bituminous mixture to form a membrane.

While the contents of the bituminous mixture are not critical to this invention, typically they primarily include an asphalt component, a polymeric component, and a filler component. The mixture can also include other ingredients such as flame retardants, ultraviolet stabilizers and dispensing aids.

The asphalt component can include a wide range of raw materials which are for the most part naturally occurring modified hydrocarbons that are typically collected as a residue of petroleum distillation.

Examples of polymeric materials that can be added to the bituminous mixture include purposefully synthesized amorphous copolymer of propylene and ethylene, isotactic polypropylene, atactic polypropylene, or mixtures thereof, as generally described in ASTMD 6223. Or, the polymeric materials may include styrene-butadiene-styrene copolymer, styrene-ethylene/butadiene-styrene copolymer, styrene-isoprene-styrene copolymer, or mixtures thereof. In general, useful polymeric materials include those that meet ASTM D 6162.

The filler component of the mixture can be any conventional filler that is employed in making bituminous mixtures for roofing membranes as would be evident to one skilled in the art. Typical of such fillers are calcium carbonate, mica, clay, talc, diatomaceous earth, mineral slag, titanium dioxide, silicas, ground cement, and spent lime.

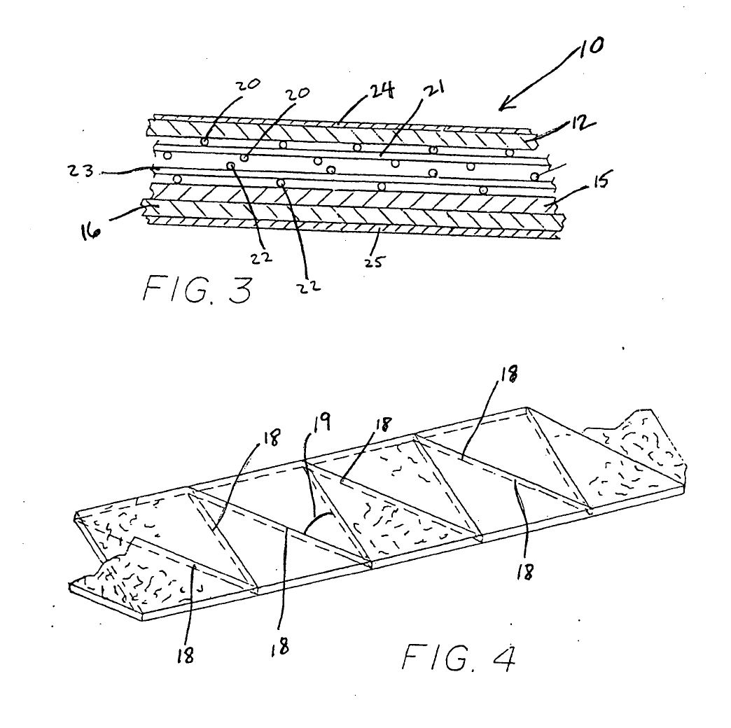

As shown in FIG. 3, when the composite 11 is impregnated and coated with the bituminous mixture to create membrane 10. In one preferred embodiment, the composite material 11 is positioned closer to the top of membrane 10 resulting in an upper surface 24 of the bituminous material that is thinner than the lower surface 25. This configuration results in a membrane 10 which is less likely to experience cracking while at the same time providing a sufficiently thick lower surface 25 to allow membrane 10 to be heat welded, and providing a sufficiently thick overall membrane to provide adequate weathering protection.

The finished membrane 10 is typically about 90 to about 120 centimeters wide and about 7 to about 20 meters long and is provided on a roll. In one embodiment, a preferred thickness of the finished membrane 10 preferably comprises about 80 mils to about 225 mils. Typically, it is unrolled on a roof surface and fused into place by using a propane gas burner or other hot air equipment. Alternative techniques which may be made to apply finished membrane 10 include applying a suitable solvent cutback asphalt, hot oxidized asphalt, or hot polymer (SEBS) modified asphalt to mat 10. When applying the membrane to the roof surface, edges of the membrane are overlapped and fused to ensure a watertight seal.

The composite of this certain embodiments of this invention advantageously allows for the manufacture of membranes that can meet the various standards of ASTM D6162 or ASTM D6223, which depend on the polymeric bituminous mixture employed. Moreover, by increasing the number of warp and weft yarns within the scrim layers, the composites of certain embodiments of this invention can be tailored to meet the various levels of thresholds within the ASTM D6162 or D6223 standards.

Various modifications and alterations that do not depart from the scope and spirit of this invention will become apparent to those skilled in the art. This invention is not to be duly limited to the illustrative embodiments set forth herein.

1. A composite material for reinforcing roofing membranes comprising a first layer in the form of a mat, a second layer in the form of a non-woven scrim made of a fiberglass material, an optional third layer in the form of a non-woven scrim made of a polyester material, a fourth layer in the form of a mat, and a fifth layer in the form of a mat.

2. The composite material of claim 1 wherein said non-woven scrim made of a fiberglass material comprises at least 4 yarns per inch in the machine direction and at least 4 yarns per inch in the cross direction.

3. The composite material of claim 1 wherein said non-woven scrim made of a fiberglass material comprises at least 6 yarns per inch in the machine direction and at least 6 yarns per inch in the cross direction.

4. The composite material of claim 1 wherein said non-woven scrim made of a fiberglass material comprises more yarns per square inch in the cross direction than yarns per square inch in the machine direction.

5. A method of making a composite material for reinforcing roofing membranes comprising the steps of forming a first mat layer, forming a first scrim layer, positioning the first scrim layer adjacent to the first mat layer, forming a second scrim layer, positioning the second scrim layer adjacent to the first scrim layer, forming a second mat layer, positioning the second mat layer adjacent to the second scrim layer, forming a third mat layer, positioning the third mat layer adjacent to the second mat layer, and mechanically attaching the layers together to form the composite material without the use of an adhesive.

6. The method of claim 5 wherein said forming said second scrim comprises entangling fibers of polyester.

7. The method of claim 5 wherein said forming said first scrim comprises aligning a plurality of layers of fiberglass in a warp and weft design.

8. The method of claim 5 further comprising impregnating the composite material with a bituminous mixture.

9. The method of claim 8 wherein the bituminous mixture comprises asphalt.

10. The method of claim 5 wherein said forming at least one of said first, second and third mat layers comprise mechanically fastening a plurality of fibers.

11. The method of claim lo wherein said mechanically fastening comprises carding and needle punching.

12. The method of claim 5 wherein said forming at least one of said second and third mat layers comprises folding said mat to form cross-laps.

13. The method of claim 5 wherein said forming said first mat substantially devoid of employing an adhesive binder.

14. The method of claim 7 further comprising adhering said plurality of layers of fiberglass in the warp and weft design.

15. A roofing membrane comprising a bituminous impregnated single laminate composite material, said composite material including a first layer in the form of a mat, a second layer in the form of a non-woven scrim made of a fiberglass material, an optional third layer in the form of a non-woven scrim made of a polyester material, a fourth layer in the form of a mat, and a fifth layer in the form of a mat.

16. The roofing membrane of claim 15 wherein at least one of said fourth layer and said fifth layer include cross laps.

17. The roofing membrane of claim 15 wherein said non-woven scrim made of a fiberglass material comprises at least 4 yarns per inch in the machine direction and at least 4 yarns per inch in the cross direction.

18. The roofing membrane of claim 15 wherein said non-woven scrim made of a fiberglass material comprises more yarns per square inch in the cross direction than yarns per square inch in the machine direction.

19. The roofing membrane of claim 15 wherein said bituminous impregnate comprises asphalt, a polymeric material, and a filler.

20. The roofing membrane of claim 15 further comprising a bituminous layer on a top surface of the roofing membrane.
